(19) United States
(12) Patent Application Publication
(10) Pub. No.: US 2025/0035175 A1
(43) Pub. Date: Jan. 30, 2025

(54) BRAKE ELEMENT FOR A MOTOR VEHICLE, AND METHOD FOR MANUFACTURING A BRAKE ELEMENT

(71) Applicant: Volkswagen Aktiengesellschaft, Wolfsburg (DE)

(72) Inventors: Stefan RICHTER, Roetgesbuettel (DE); Fabian BEHM, Braunschweig (DE); Markus HARKE, Braunschweig (DE); Klaus Stefan KLIMEK, Bovenden (DE)

(73) Assignee: Volkswagen Aktiengesellschaft, Wolfsburg (DE)

(21) Appl. No.: 18/782,968

(22) Filed: Jul. 24, 2024

(30) Foreign Application Priority Data
Jul. 24, 2023 (DE) 10 2023 207 017.0

(51) Int. Cl. F16D 65/12; F16D 65/02; F16D 69/02

(52) U.S. Cl. CPC F16D 65/127; F16D 69/027; F16D 2065/132; F16D 2065/1328; F16D 2200/0021; F16D 2200/006

(57) ABSTRACT

A brake element for a motor vehicle, having a base body that is planar at least in areas, to the planar sides of which at least two build-up layers are applied in each case, at least in areas. The build-up layers form a surface which, in the mounted state of the brake element on the motor vehicle, is used as a friction surface for a brake pad. A first build-up layer is present that adjoins the base body, and a second build-up layer is applied to the first build-up layer. The second build-up layer is made of a composite of an iron alloy matrix with intercalated tungsten carbide particles or with intercalated titanium carbide particles. At least the first build-up layer is an iron alloy that is alloyed at least with molybdenum in a range of 3 to 20 weight percent.

This nonprovisional application claims priority under 35 U.S.C. § 119 (a) to German Patent Application No. 10 2023 207 017.0, which was filed in Germany on Jul. 24, 2023, and which is herein incorporated by reference.

### BACKGROUND OF THE INVENTION

### Field of the Invention

The invention relates to a brake element for a motor vehicle.

### Description of the Background Art

Brake elements, for example brake discs or brake disc friction rings, are typically manufactured from gray cast iron. The benefits of gray cast iron, in particular the high volumetric heat capacity and the relative thermal shock resistance, are offset by various drawbacks. These include the high weight, the pronounced tendency for corrosion, and the high level of wear on the material during operation of a motor vehicle.

Corrosion results in an impaired appearance, since the brake element is the only part in the motor vehicle that forms red rust within a short period of time. In addition, brake discs are directly visible through the open aluminum wheel rims that are often used.

For economical driving or for large amounts of regeneration (when braking is only seldom performed), the tendency of the material to corrode may possibly result in such severe damage to the brake element that it must be replaced prematurely.

Furthermore, the friction wear on a brake element results in emissions of fine particulate matter which can greatly exceed those from a modern internal combustion engine.

To eliminate these disadvantages, previous known approaches have been to completely substitute the material of the brake element with hard, corrosion-resistant materials (ceramic, for example) and also to protect the friction surfaces of the brake element with a suitable coating.

Thus, there are various problem-solving approaches for coatings, in particular the friction surfaces of the brake element that are subject to particular wear, which are intended for use as combined wear protection and corrosion protection. The coating takes place using thermal spraying processes to apply oxide ceramic coatings or coatings containing hard materials. Various coating materials based on metallic alloys or composites of ceramic or hard metal particles, which have improved behavior with regard to corrosion and wear, are thus used in the metallic matrix.

Examples of thermal spraying processes include high-velocity flame spraying, plasma spraying, cold gas spraying, or wire arc spraying.

A brake element for a motor vehicle is known from DE 10 2021 207 133 B3, which corresponds to US 2023/0013186, which is incorporated herein by reference. In particular, to increase the wear resistance and to reduce the tendency for cracking in the build-up layers, it is proposed that the first build-up layer has a thickness in a range of 40 μm to 120 μm, and the second build-up layer has a thickness in a range of 60 μm to 420 μm. The second build-up layer is made of a composite of an iron alloy matrix with intercalated tungsten carbide particles, the proportion of the volume of the intercalated tungsten carbide particles to the volume of the iron alloy matrix being in a range of 20% to 40%.

EP 3 325 685 B1, which is incorporated herein by reference, describes a cylinder crankcase with a coated cylinder working surface. The coating of the cylinder working surface has a mixed layer made of a base material and an adhesion promoter. In turn, a layer of the base material is applied to the mixed layer. The base material is iron or an iron alloy, while the adhesion promoter contains a mixture of 20 to 80 weight percent molybdenum and 20 to 80 weight percent of an aluminum-containing alloy.

### SUMMARY OF THE INVENTION

It is therefore an object underlying the present invention to provide a brake element for a motor vehicle that has improved properties with regard to wear resistance and tendency for cracking.

The invention proceeds from a brake element for a motor vehicle, having a base body that is planar at least in areas, to the planar sides of which at least two build-up layers are applied in each case, at least in areas.

The invention proceeds from a brake element for a motor vehicle, having a base body that is planar at least in areas, to the planar sides of which at least two build-up layers are applied in each case, at least in areas. The build-up layers form a surface which, in the mounted state of the brake element on the motor vehicle, is used as a friction surface for a brake pad. A first build-up layer is present that adjoins the base body. A second build-up layer is applied to the first build-up layer, the second build-up layer being made of a composite of an iron alloy matrix with intercalated tungsten carbide particles or with intercalated titanium carbide particles.

At least the first build-up layer can be an iron alloy that is alloyed at least with molybdenum (Mo) in a range of approximately 3 to approximately 20 weight percent, preferably in a range of approximately 3 to approximately 12 weight percent. Alloying of the first build-up layer with molybdenum at approximately 10 weight percent is particularly preferred. In other words, the proportion of the mass of the alloyed molybdenum to the total mass of the first build-up layer is in a range of approximately 3 to approximately 20 percent.

The second build-up layer can also be alloyed with molybdenum in a range of approximately 3 to approximately 20 weight percent, preferably in a range of approximately 3 to approximately 12 weight percent. Alloying of the second build-up layer with molybdenum at approximately 10 weight percent is particularly preferred.

The tendency for wear and cracking of the brake disc may be further reduced in this way.

When a composite made of an iron alloy matrix with intercalated tungsten carbide particles is present in the second build-up layer, the proportion of the volume of the intercalated tungsten carbide particles to the volume of the iron alloy matrix can be in a range of approximately 10% to approximately 20%.

When a composite made of an iron alloy matrix with intercalated titanium carbide particles is present in the second build-up layer, the proportion of the volume of the intercalated titanium carbide particles to the volume of the iron alloy matrix can be in a range of approximately 10% to approximately 40%, preferably in a range of approximately 15% to approximately 30%, and particularly preferably approximately 20%.

Due to the above-mentioned volume distributions, the tendency for cracking, in particular in the second build-up layer, may be further reduced, and high wear resistance and a good friction coefficient during use of the brake element may be achieved.

The first build-up layer can be made of an austenitic stainless steel having material properties corresponding to the material 1.4404 according to the DIN EN 10027-2 standard, or to the material 316L according to the AISI standard.

However, depending on the material properties of the base body of the brake element, it is alternatively conceivable and has proven advantageous for the first build-up layer to be made of a ferritic stainless steel having material properties corresponding to the material 1.4016 according to the DIN EN 10027-2 standard, or to the material 430L according to the AISI standard.

By use of the above-mentioned examples, the first build-up layer may be optimally matched to the particular material properties of the base body, in particular to the thermal expansion coefficient thereof.

The brake element may be refined by having the first build-up layer a thickness be in a range of approximately 50 μm to approximately 350 μm, viewed perpendicularly with respect to an areal extent of a planar side.

The second build-up layer can have a thickness in a range of approximately 60 μm to approximately 420 μm, viewed perpendicularly with respect to an areal extent of a planar side.

The iron alloy matrix in the second build-up layer can be made of a material having material properties corresponding to the material 1.4404 according to the DIN EN 10027-2 standard, or to the material 316L according to the AISI standard. This example is advantageous in particular when the first build-up layer contains such a material.

The iron alloy matrix in the second build-up layer may be made of a material having material properties corresponding to the material 1.4016 according to the DIN EN 10027-2 standard, or to the material 430L according to the AISI standard. This example is advantageous in particular when the first build-up layer contains such a material.

When the iron alloy in the first build-up layer is appropriately selected, such refinements may contribute to better adhesion of the second build-up layer.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a motor vehicle with brake elements according to the invention;

FIG. 2 shows a cross section of a brake element illustrated individually;

FIG. 3 shows a detailed illustration according to detail III from FIG. 2; and

FIG. 4 shows the illustration of a process step in the method for manufacturing the brake element.

### DETAILED DESCRIPTION

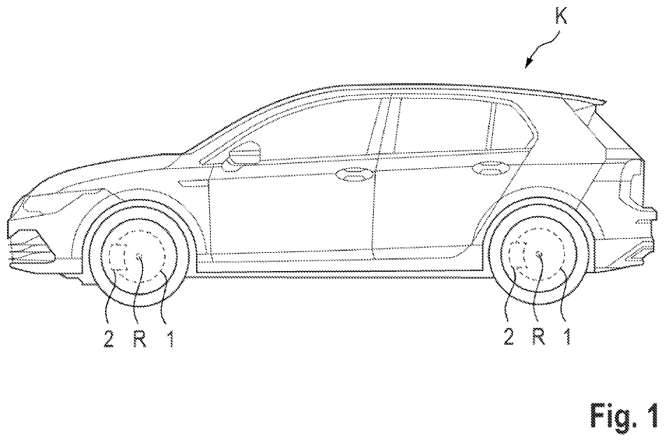

Reference is first made to FIG. 1, which shows a motor vehicle K that is equipped with brake elements 1 according to the invention. The brake elements 1 are designed as disc brakes, and are mounted on a wheel carrier, and rotate about a rotational axis R. Brake calipers 2 each contain movable brake pads, for which the brake element 1 via its brake disc friction rings forms a friction surface. When the brake pads are pressed against the friction surface of the brake element 1, the motor vehicle K is decelerated or stopped.

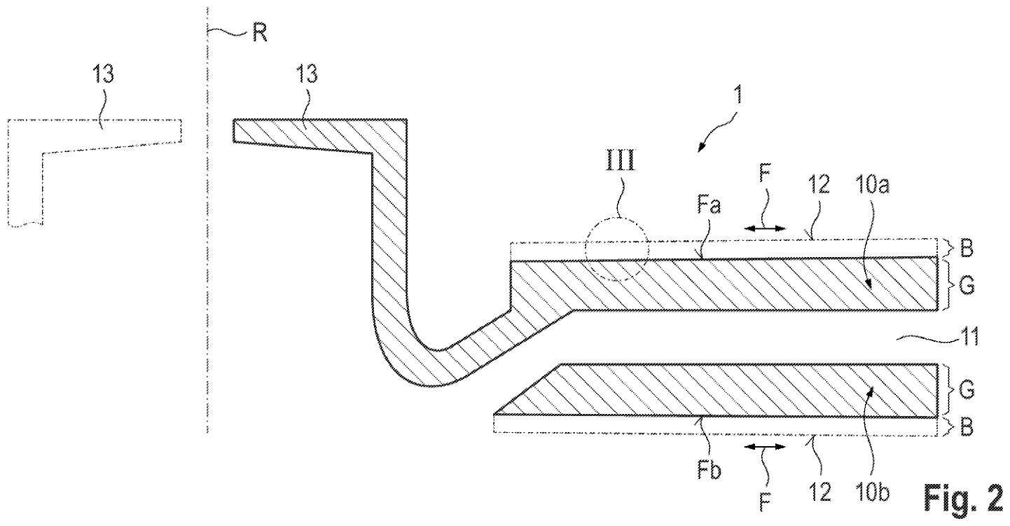

FIG. 2 shows a brake element 1 in an individual illustration, in cross section. The brake element 1 rotates about the imaginary rotational axis R. For reasons of rotational symmetry, only half of the brake element 1 is illustrated.

It is apparent that the brake element 1 in the example is designed as an internally vented brake disc having two friction rings 10a and 10b. In a departure from the example, a brake disc with only one friction ring is also conceivable. A ventilation space 11 is present between the friction rings 10a, 10b. Necessary spacer ribs may be arranged between the friction rings 10a, 10b. Each friction ring 10a, 10b has a planar base body G with a planar side Fa or Fb. Each planar side Fa, Fb has an areal extent F and is provided with a coating B. The coating B in each case forms a friction surface 12 that is active during braking.

In example, the coating B in each case extends over the entire planar side Fa or Fb of the base body G. In a departure therefrom, it is also conceivable for the coating B to be applied only to the region of the planar sides Fa, Fb that is covered by the brake pads.

Reference numeral 13 denotes a hub of the brake element 1 that is used for mounting the brake element 1 on a wheel carrier.

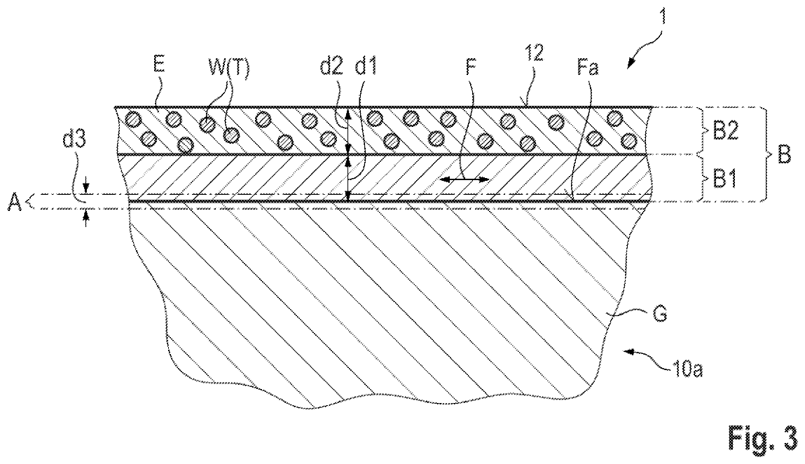

A detail area from the cross section of the brake element 1 is apparent from FIG. 3. In particular, it is discernible that the coating B is made up of a first build-up layer B1 and a second build-up layer B2.

The first build-up layer B1 is applied directly to the base body G, and thus directly adjoins it. The second build-up layer B2 is in turn applied to the first build-up layer B1.

It is indicated here that the first build-up layer B1 has a thickness d1 perpendicular to the areal extent F of the planar side Fa (or Fb). This thickness d1 is preferably in a range of approximately 50 microns to approximately 350 microns.

In contrast, the second build-up layer B2 has a thickness d2 that is preferably in a range of approximately 60 microns to approximately 420 microns.

As a result of these layer thickness ranges, the first build-up layer B1 can optimally fulfill the purpose of corrosion protection and inhibition of cracks from the second build-up layer B2.

The stated thickness range of the second build-up layer B2 meets the requirement for high wear resistance, as a result of which particulate emissions due to friction wear may be greatly reduced.

Furthermore, a mixing or bonding zone A is indicated which lies in a transition between the base body G and the adjoining first build-up layer B1. The bonding zone A is characterized in that a certain amount of blending takes place here between the material of the base body G and the material of the coating B1. The bonding zone A has a thickness d3, perpendicular to the areal extent F, which is very thin and less than 10 microns. The bonding zone A preferably has a thickness d3 that is less than 5 microns.

It has been shown that due to such a small thickness of the bonding zone A, on the one hand granulation and hardening of the first build-up layer B1 may be prevented, and on the other hand good adhesion of the first build-up layer B1 to the base body G is still achievable. Adhesive tensile strengths of well above 50 MPa may be achieved. The basic requirements for high wear resistance and a high level of corrosion protection may thus be provided.

A more detailed discussion of the materials used is provided below. The base body G is manufactured from gray cast iron. Together with the hub 13 (see FIG. 2), it is manufactured using a conventional casting process.

The first build-up layer B1 is made of an iron alloy, preferably an austenitic stainless steel, that represents a particularly ductile, tough iron alloy. The material of the first build-up layer B1 particularly preferably has material properties corresponding to the material 1.4404 according to the DIN EN 10027-2 standard, or to the material 316L according to the AISI standard.

Furthermore, as an important feature the iron alloy in the first build-up layer B1 is alloyed with molybdenum. The alloying is in a range of approximately 3 to approximately 20 weight percent, preferably in a range of approximately 3 to approximately 12 weight percent. Alloying of the first build-up layer B1 with molybdenum is particularly preferably approximately 10 weight percent. In other words, the proportion of the mass of the alloyed molybdenum to the total mass of the first build-up layer B1 is in a range of approximately 3 to approximately 20 percent.

However, it is also conceivable for the iron alloy in the first build-up layer B1 to be made of a ferritic stainless steel. This ferritic stainless steel may preferably have material properties corresponding to the material 1.4016 according to the DIN EN 10027-2 standard, or to the material 430L according to the AISI standard. However, in this case as well, as an important feature the iron alloy in the first build-up layer B1 is alloyed with molybdenum in the same manner as described above.

The second build-up layer B2 is made of a composite of an iron alloy matrix E with intercalated tungsten carbide particles W. It has been found to be particularly advantageous when the proportion of the volume of the intercalated tungsten carbide particles W to the volume of the iron alloy matrix E in the second build-up layer B2 is in a range of approximately 10 percent to approximately 20 percent.

As an alternative, it is conceivable for the second build-up layer B2 to be made of a composite of an iron alloy matrix E with intercalated titanium carbide particles T. In this case, it has been found to be particularly advantageous when the proportion of the volume of the intercalated titanium carbide particles T to the volume of the iron alloy matrix E in the second build-up layer B2 is in a range of approximately 10 percent to approximately 40 percent.

As the result of such a volume distribution, on the one hand an increased tendency for crack formation in the second build-up layer B2 may be prevented, and on the other hand the wear on the second build-up layer B2 may be limited, with good friction coefficients and low emission values.

Regardless of whether the second build-up layer B2 includes intercalated tungsten carbide particles W or intercalated titanium carbide particles T, the second build-up layer B2 may also be advantageously alloyed with molybdenum. The alloying may be in a range of approximately 3 to approximately 20 weight percent, preferably in a range of approximately 3 to approximately 12 weight percent. Alloying of the second build-up layer B2 with molybdenum at approximately 10 weight percent is particularly preferred. In other words, the proportion of the mass of the alloyed molybdenum to the total mass of the second build-up layer B2 may be in a range of approximately 3 to approximately 20 percent.

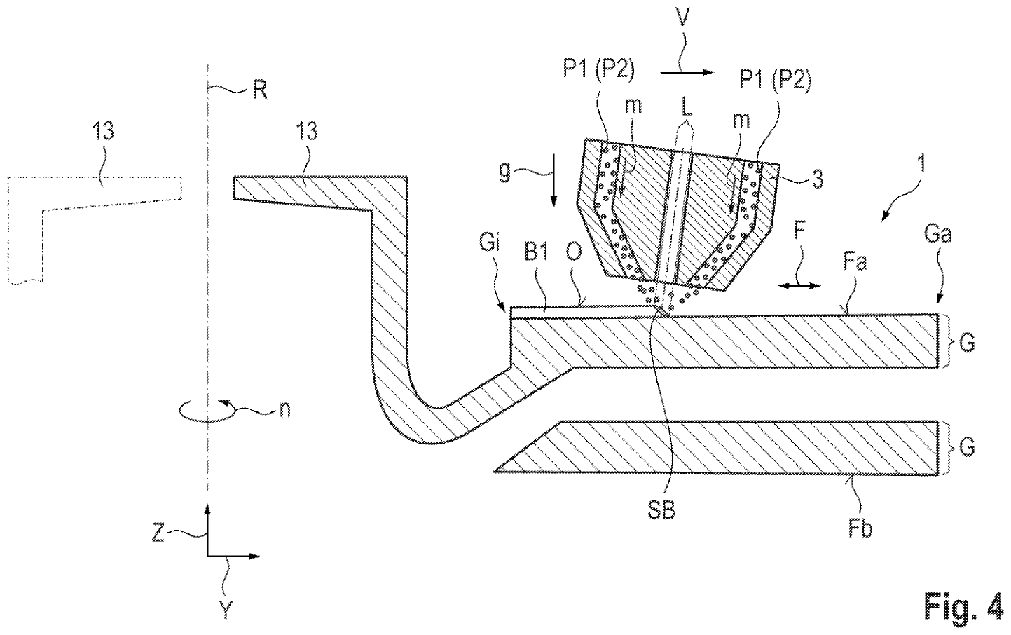

A first process step in manufacturing the coating B (see FIG. 3) of the brake element 1 is now explained with reference to FIG. 4. The coating of the brake element 1 preferably takes place using so-called high-velocity laser build-up welding. First, by use of a device, the base body G of the brake element 1 is oriented with its rotational axis R vertical, i.e., oriented in a vertical direction Z, in such a way that the planar side Fa with its areal extent F is oriented in parallel to a horizontal direction Y.

The base body G, i.e., the uncoated brake disc, has previously been manufactured according to a customary series production process.

A coating tool 3 is present, approximately parallel to the rotational axis R. The coating tool 3 is uniaxially movable, orthogonally or radially with respect to the rotational axis R and in parallel to the horizontal direction Y. The coating tool has at least one laser optics system for generating a laser beam L, and a nozzle for ejecting a first powdered coating material P1. At least one laser source and at least one powder conveyor are connected to the coating tool 3.

The base body G is subsequently set in rapid rotation so that it rotates about the rotational axis R at a certain rotational speed n. The coating of the base body G begins at a radially inner position Gi, and is continued in the direction of a radially outer position Ga of the base body G via a radial feed motion V.

Simultaneously with the generation of the laser beam L, the mentioned powder conveyor is put into operation in such a way that the first powdered coating material P1 is conveyed with a certain powder mass flow m. The powdered coating material P1 is made up of powder grains having a spherical, i.e., ball-shaped, form, and has a material composition corresponding to the first build-up layer B1 to be produced. The powdered coating material P1 thus contains an iron alloy (316L or 430L) and molybdenum as components.

Depending on the instantaneous position of the coating tool 3, the rotational speed n of the base body G is adjusted in order to achieve a constant thickness of the build-up layer B1 over the entire surface of the planar side Fa to be coated.

In the coating method, the radiation intensity of the laser beam L is set in a range such that overheating of the respective build-up layer B1 or B2 to be applied does not take place.

In the illustrated coating method, the coating material, i.e., the powdered coating material P1, is melted. For this purpose, the powdered coating material P1 is supplied in a targeted manner by the coating tool 3 to the laser beam L that strikes the base body G, i.e., the laser spot. At that location the powdered coating material P1 is melted and forms a molten pool SB.

In contrast, the base body G itself does not form a molten pool, and instead is only locally heated to a temperature just below its melting temperature. Therefore, unmelted particles of the powdered coating material P1 are not introduced into a melt of the base body G; rather, a molten pool SB made up of the particles of the powdered coating material P1 is deposited. At the immediate boundary surface between the molten coating material (P1 in the figure) and the locally intensely heated surface of the substrate (base body G here), a diffusion process results in very good bonding of the coating material (P1 here) to the substrate (base body G here), without increased blending of the involved materials taking place.

As a result of the powdered coating material P1 being brought into the laser beam L in the direction of gravitational acceleration g, it can remain in the laser beam L as long as possible, and good melting can take place.

It is noted that during the coating, the coating tool 3 is moved radially outwardly with a feed motion v.

In addition, a feed motion v of the coating tool and a rotational speed of the brake element 1 are coordinated with one another in such a way that, during a complete rotation of the brake element 1 by 360 degrees, a certain overlap from a coating track that is applied during the rotation and a previously applied coating track results.

When the first build-up layer B1 is applied to the base body G as desired, the second layer B2 is correspondingly applied to a surface O of the first build-up layer B1. Coating material P2 is then supplied which corresponds to the material composition of the second build-up layer B2 to be produced, i.e., containing an iron alloy (316L or 430L), tungsten carbide or titanium carbide, and molybdenum as components.

The coating tool 3 is once again moved radially from the inside to the outside, analogously to the first process step. However, for applying the second build-up layer B2, the second powdered coating material P2 is now supplied to the laser beam L. The second powdered coating material is preferably present in powder grains having a spherical shape.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A brake element for a motor vehicle, the brake element comprising:
a base body that is planar at least in areas to planar sides of which at least two build-up layers are applied, at least in areas, the build-up layers forming a surface which, in a mounted state of the brake element on the motor vehicle, is used as a friction surface for a brake pad;
a first build-up layer that adjoins the base body; and
a second build-up layer being applied to the first build-up layer, the second build-up layer being made of a composite of an iron alloy matrix with intercalated tungsten carbide particles or with intercalated titanium carbide particles,
wherein at least the first build-up layer is an iron alloy that is alloyed at least with molybdenum in a range of 3 wt % to 20 wt %.

2. The brake element according to claim 1, wherein the second build-up layer is also alloyed at least with molybdenum in a range of 3 wt % to 20 wt %.

3. The brake element according to claim 1, wherein the proportion of a volume of the intercalated tungsten carbide particles to a volume of the iron alloy matrix is in a range of 10% to 20%.

4. The brake element according to claim 1, wherein the proportion of a volume of the intercalated titanium carbide particles to a volume of the iron alloy matrix is in a range of 10% to 40%.

5. The brake element according to claim 1, wherein the iron alloy in the first build-up layer is made of an austenitic stainless steel having material properties corresponding to the material 1.4404 according to the DIN EN 10027-2 standard, or to the material 316L according to the AISI standard.

6. The brake element according to claim 1, wherein the iron alloy of the first build-up layer is made of a ferritic stainless steel having material properties corresponding to the material 1.4016 according to the DIN EN 10027-2 standard, or to the material 430L according to the AISI standard.

7. The brake element according to claim 1, wherein the first build-up layer, viewed substantially perpendicularly with respect to an areal extent of a planar side, has a thickness in a range of 50 μm to 350 μm.

8. The brake element according to claim 1, wherein the second build-up layer, viewed substantially perpendicularly with respect to an areal extent of a planar side, has a thickness in a range of 60 μm to 420 μm.

9. The brake element according to claim 1, wherein the iron alloy matrix in the second build-up layer is made of a material that has material properties corresponding to the material 1.4404 according to DIN EN 10027-2 standard, or to the material 316L according to the AISI standard.

10. The brake element according to claim 1, wherein the iron alloy matrix in the second build-up layer is made of a material that has material properties corresponding to the material 1.4016 according to the DIN EN 10027-2 standard, or to the material 430L according to the AISI standard.
